(19) United States
(12) Patent Application Publication
(10) Pub. No.: US 2014/0109943 A1
(43) Pub. Date: Apr. 24, 2014

(54) WALKER

(71) Applicant: Hui Zhou Andon Industries Co., Ltd., Hui Zhou City (CN)

(72) Inventor: James Fang, Taipei (TW)

(73) Assignee: Hui Zhou Andon Industries Co., Ltd., Hui Zhou City (CN)

(21) Appl. No.: 14/055,115

(22) Filed: Oct. 16, 2013

(30) Foreign Application Priority Data
Oct. 23, 2012 (CN) 201220541579.9

(51) Int. Cl. A61H 3/00

(52) U.S. Cl. CPC A61H 3/00
USPC 135/67

(57) ABSTRACT

A walker includes a connecting portion including two connecting units, each connecting unit having a first end and a second end, the first end of one of the connecting units detachably connected to the first end of the other connecting unit; and a fastening unit detachably disposed on the junction between the connecting units to connect the connecting units; and two supporting members oppositely disposed and rotatably connected to the second ends of the connecting units respectively.

### CROSS-REFERENCE TO RELATED APPLICATIONS

This application is based upon and claims priority under 35 U.S.C. 119 from China Patent Application No. 201220541579.9 filed on Oct. 23, 2012, which is hereby specifically incorporated herein by this reference thereto.

### BACKGROUND OF THE INVENTION

1. Field of the Invention

The present invention relates to a walker, and in particular to a foldable walker.

2. Description of the Prior Arts

Various walkers are provided on market for persons who need mobility assistance for the lower limbs, such as the elderly or injured people undergoing rehabilitation.

Referring to FIG. 10, a conventional walker includes two hand frames 40 and a connecting rod 50 connecting the hand frames 40. Each hand frame 40 has two legs 41. When the conventional walker is in use, a user stands between the hand frames 40 and behind the connecting rod 50. The user's hands hold the hand frames 40 to move the walker for a short distance in the direction the user would like to walk, and then the hand frames 40 are pushed to create a reaction force exerted on the user to reduce the weight sustained by the user's lower limbs for walking easily. Thus, the walker can assist the user with walking.

For easy storage, the connecting rod 50 is rotatable with respect to each hand frame 40. Referring to FIG. 11, when the walker is to be stored, the two hand frames 40 are rotated to overlap each other and rest on one side of the connecting rod 50, thereby reducing the space occupied by the folded walker, and the walker is thus easily stored by abutting on a wall or a cabinet or placed under a bed.

The connecting rod 50 has a suitable length to provide a sufficient space between the hand frames 40 for most users. Furthermore, since each hand frame 40 has a length large enough for holding, the length of each hand frame 40 is usually smaller than the length of the connecting rod 50. The folded length of the walker is therefore equal to the length of the connecting rod 50, which is still quite an obstacle for storage. When the walker is placed abutting on a cabinet, the walker may protrude relative to the cabinet such that people passing by may stumble, and since the walker still has a considerable length, the shipping cost cannot be reduced.

To overcome the shortcomings, the present invention provides a foldable walker to mitigate or obviate the aforementioned problems.

### SUMMARY OF THE INVENTION

The object of the present invention is to provide a foldable walker which has a reduced folded length to facilitate easy storage and shipping.

To achieve the object, the present invention provides a walker including a connecting portion including two connecting units, each connecting unit having a first end and a second end, the first end of one of the connecting units detachably connected to the first end of the other connecting unit; and a fastening unit detachably disposed on a junction between the connecting units to connect the connecting units; and two supporting members oppositely disposed and rotatably connected to the second ends of the connecting units respectively.

The advantages of the present invention are described as follows. Since the connecting portion includes the two connecting units, the connecting portion can be folded to a reduced length, thereby facilitating easy storage and reducing the volume to save the shipping cost, which has the effect of energy conservation and carbon reduction.

Furthermore, the first end of one of the connecting units is fitted to the first end of the other connecting unit.

Furthermore, the fastening unit comprises at least one plug detachably inserted into the connecting units and a fastening member connected to the at least one plug and abutting one of the connecting units.

Furthermore, in a preferred embodiment, the fastening member includes an abutting portion detachably abutting the first end of the connecting unit, a fixed end formed at one end of the abutting portion and fixed to one end of the at least one plug, and a mounting end formed at another end of the abutting portion and detachably connected to another end of the at least one plug.

Furthermore, in a preferred embodiment, the mounting ends are horizontally connected to the connecting units.

Furthermore, in a preferred embodiment, the mounting ends are vertically connected to the connecting units.

Furthermore, in another preferred embodiment, the fastening member includes an abutting portion having two mounting ends detachably connected to the connecting units respectively, and the abutting portion is connected to the at least one plug and detachably abuts the first end of the connecting unit.

Furthermore, the connecting units are hollow, and the connecting portion further comprises an elastic member having two ends fixed to inner sides of the connecting units.

Furthermore, the walker further includes two latch units disposed oppositely at junctions between the supporting members and the connecting units, wherein each latch unit includes a sleeve fitted to the supporting member and a rod slidably disposed in the sleeve, each connecting unit includes a connecting sheet surrounding the second end, and the rod is detachably joined to the connecting sheet.

Furthermore, each supporting member comprises a front leg, a rear leg, and a transverse rod disposed between the front leg and the rear leg, an upper end of the front leg is joined to an upper end of the rear leg to form an armrest portion, the second end of each connecting unit is fitted to the front leg correspondingly, and the sleeve is fitted to the front leg.

Furthermore, each front leg comprises a first section, a second section detachably fitted to the first section, and a second elastic member connecting the first and second sections, and each rear leg comprises a third section, a fourth section detachably fitted to the third section, and a third elastic member connecting the third and fourth sections.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a preferred embodiment of a walker of the present invention;

FIG. 2 is a partially exploded view of the walker in FIG. 1;

FIG. 3 is a partially exploded view of another preferred embodiment of a walker of the present invention;

FIG. 4 is a partially exploded view of still another preferred embodiment of a walker of the present invention;

FIGS. 5 and 6 depict a folding motion of the walker of the present invention;

FIG. 7 is a partial cross sectional view of the walker of the present invention;

FIG. 8 depicts a latch motion of the walker of the present invention;

FIG. 9 depicts folded legs of the walker of the present invention;

FIG. 10 is a perspective view of a conventional walker in accordance with the prior art; and

FIG. 11 depicts the conventional walker in FIG. 10, shown folded.

### DETAILED DESCRIPTION OF THE PREFERRED EMBODIMENTS

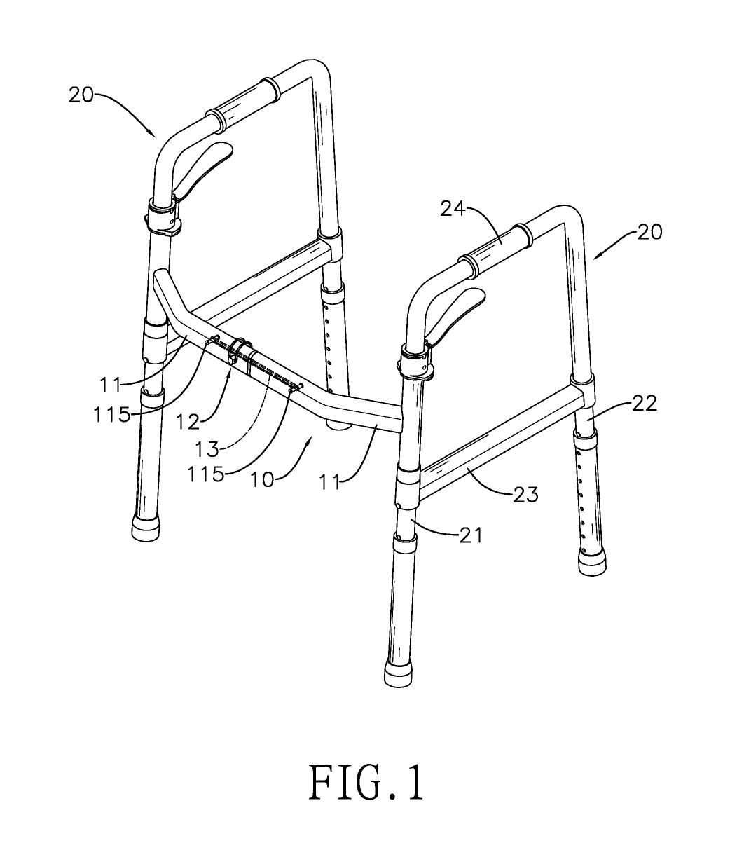

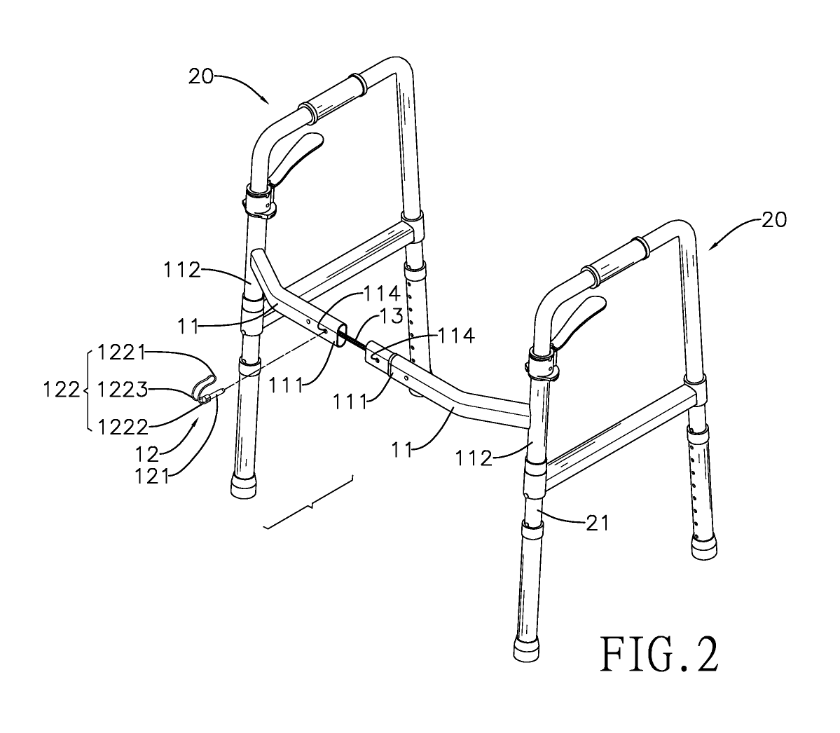

Referring to FIGS. 1 and 2, a walker of the present invention includes a connecting portion 10 and two supporting members 20.

The connecting portion 10 includes two connecting units 11 and a fastening unit 12. Each connecting unit 11 has a first end 111 and a second end 112. The first end 111 of one of the connecting units 11 is detachably connected to the first end 111 of the other connecting unit 11. In a preferred embodiment, the first end 111 of one of the connecting units 11 is fitted to the first end 111 of the other connecting unit 11. The fastening unit 12 is detachably disposed on the junction between the two connecting units 11 and connects the connecting units 11 so as to fasten the connecting units 11.

In a preferred embodiment, the fastening unit 12 includes a plug 121 and a fastening member 122. The plug 121 is detachably inserted into holes 114 formed on the two connecting units 11, and the fastening member 122 connected to the plug 121 abuts one of the connecting units 11 to fix the position of the plug 121 relative to the connecting units 11. Furthermore, each connecting unit 11 is hollow and includes a first elastic member 13. The first elastic member 13 has two ends fixed to pins 115 disposed on inner sides of the two connecting units 11 respectively. Preferably, the first elastic member 13 is an elastic cord.

In a preferred embodiment, the fastening member 122 is curved and includes an abutting portion 1221, a fixed end 1222 and a mounting end 1223. The abutting portion 1221 detachably abuts the first end 111 of the connecting unit 11. The fixed end 1222 and the mounting end 1223 are formed at two ends of the abutting portion 1221 respectively. The fixed end 1222 is fixed to one side of the plug 121, and the mounting end 1223 is detachably connected to another side of the plug 121.

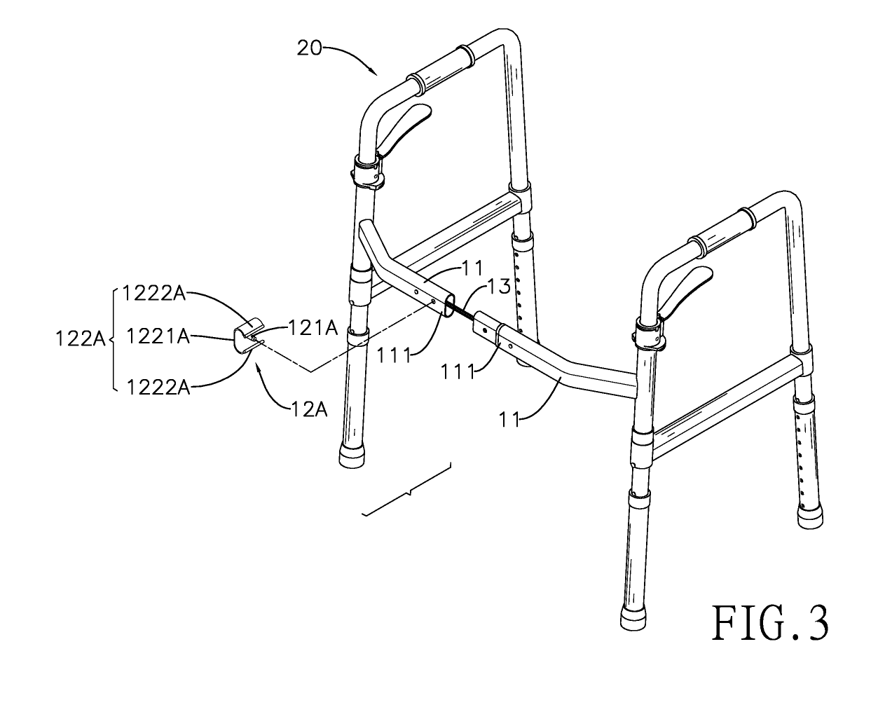

Referring to FIG. 3, in another preferred embodiment, a fastening unit 12A of the connecting portion 10 includes a plug 121A and a fastening member 122A. The fastening member 122A includes an abutting portion 1221A and two mounting ends 1222A. The two mounting ends 1222A are formed at two ends of the abutting portion 1221A and detachably clip a periphery of one of the connecting units 11. The abutting portion 1221A is connected to the plug 121A and detachably abuts the first end 111 of one of the connecting units 11. In this embodiment, the holes 114 are formed at a front side of the connecting units 11. By insertion of the plug 121A into the holes 114, the mounting ends 1222A horizontally clip the connecting units 11.

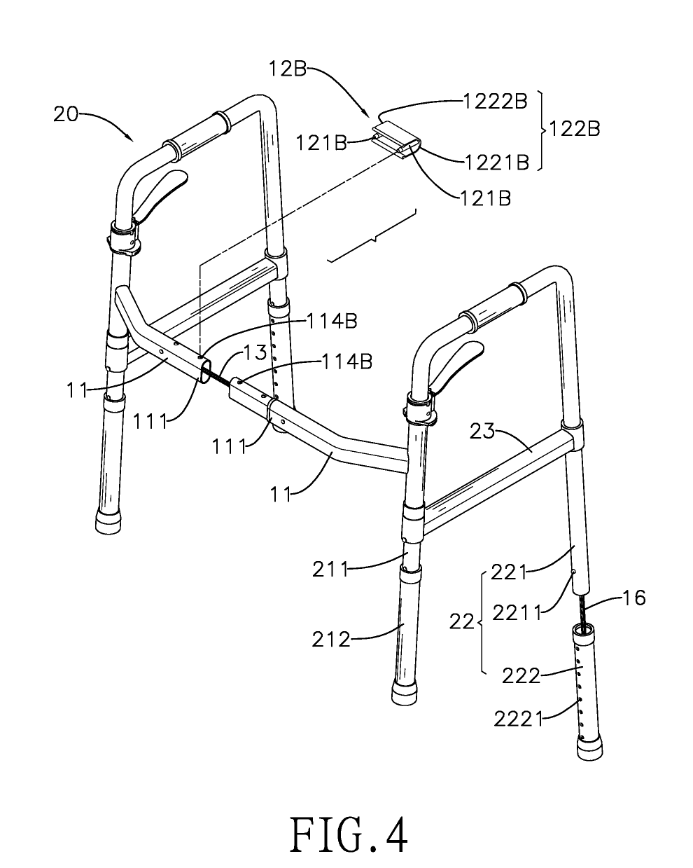

Referring to FIG. 4, in another preferred embodiment, a fastening unit 12B of the connecting portion 10 includes two plugs 121B and a fastening member 122B. The fastening member 122B includes an abutting portion 1221B and two mounting ends 1222B. The two mounting ends 1222B are formed at two ends of the abutting portion 1221B and detachably clip a periphery of one of the connecting units 11. In this embodiment, the two mounting ends 1222B are parallel to the supporting member 20. The abutting portion 1221B is connected to the plugs 121B and detachably abuts the first end 111 of one of the connecting units 11. In this embodiment, the holes 114B are formed at an upper side of the connecting units 11. By insertion of the plugs 121B into the holes 114B, the mounting ends 1222B vertically clip the connecting units 11.

Referring to FIGS. 1 and 2, the supporting members 20 are oppositely disposed and rotatably connected to the connecting units 11 of the connecting portion 10. Furthermore, the supporting members 20 are fitted to the second ends 112 of the connecting units 11. Each supporting member 20 includes a front leg 21, a rear leg 22 and a transverse rod 23. The front leg 21 is disposed opposite to the rear leg 22, and an upper end of the front leg 21 is joined to an upper end of the rear leg 22 to form an armrest portion 24. The transverse rod 23 is disposed between the front leg 21 and the rear leg 22 and connects the front leg 21 and the rear leg 22. In a preferred embodiment, the second end 112 of each connecting unit 11 is fitted to the corresponding front leg 21 of the supporting member 20.

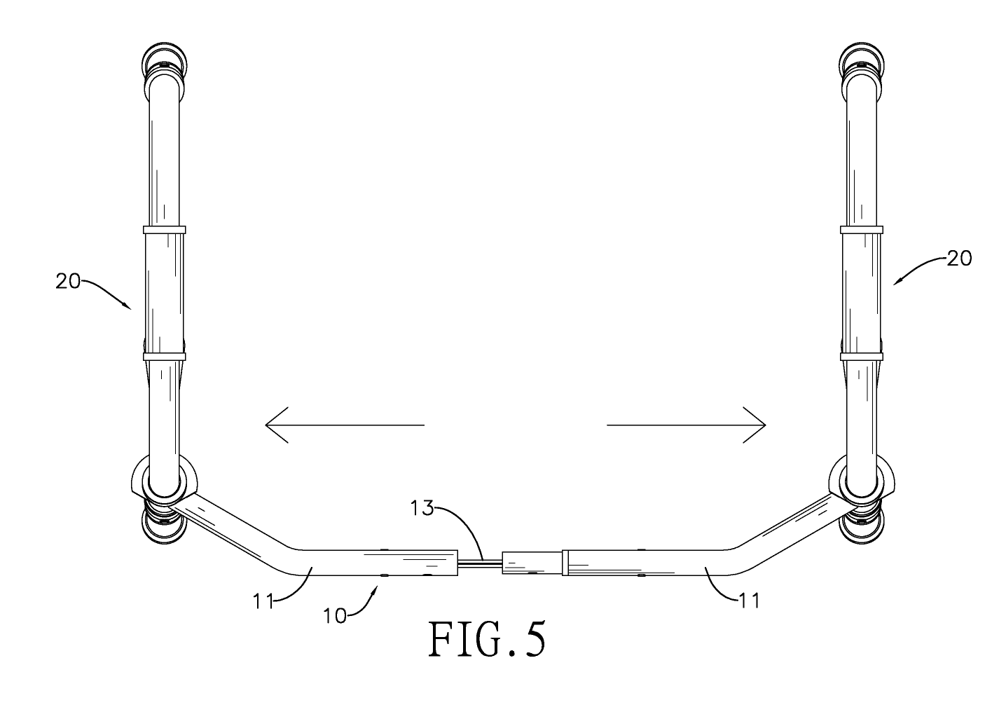

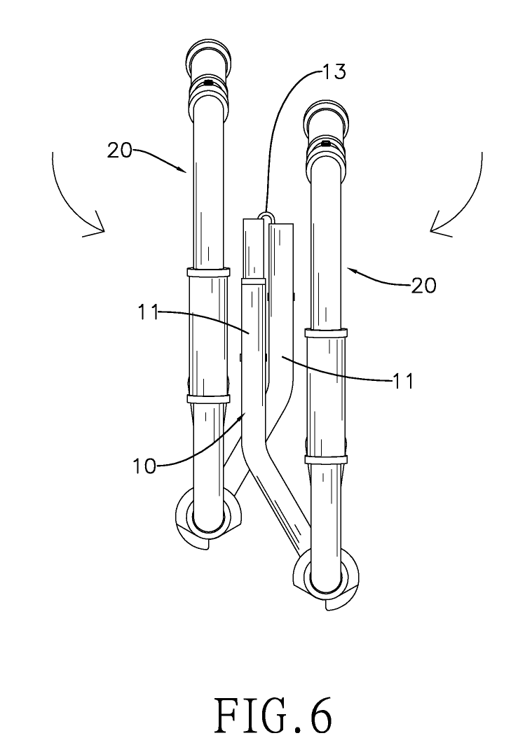

Referring to FIGS. 2, 5 and 6, when the walker is to be stored, the plug 121 is removed from the connecting units 11. Afterwards the first ends 111 of the two connecting units 11 are separated to allow each of the connecting units 11 to rotate with respect to the corresponding supporting member 20 to rest on the corresponding supporting member 20 so that the two supporting members 20 along with the folded connecting units 11 can be folded together.

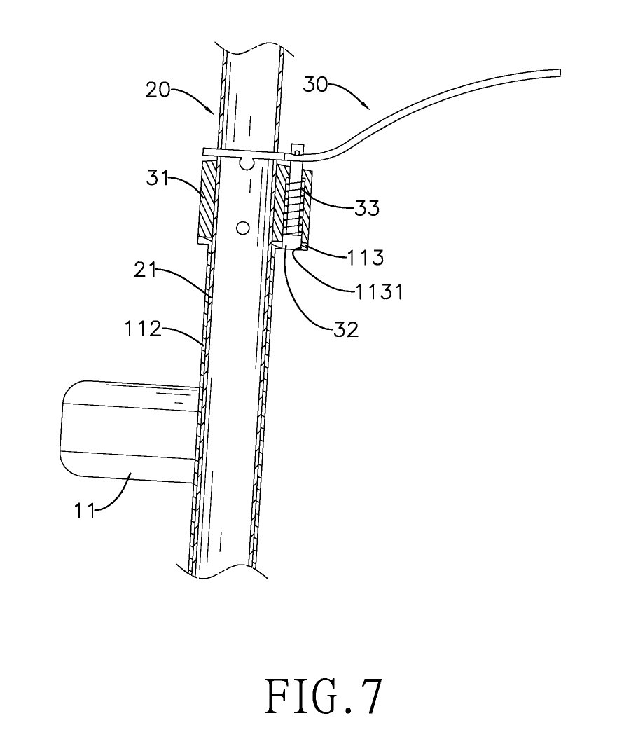

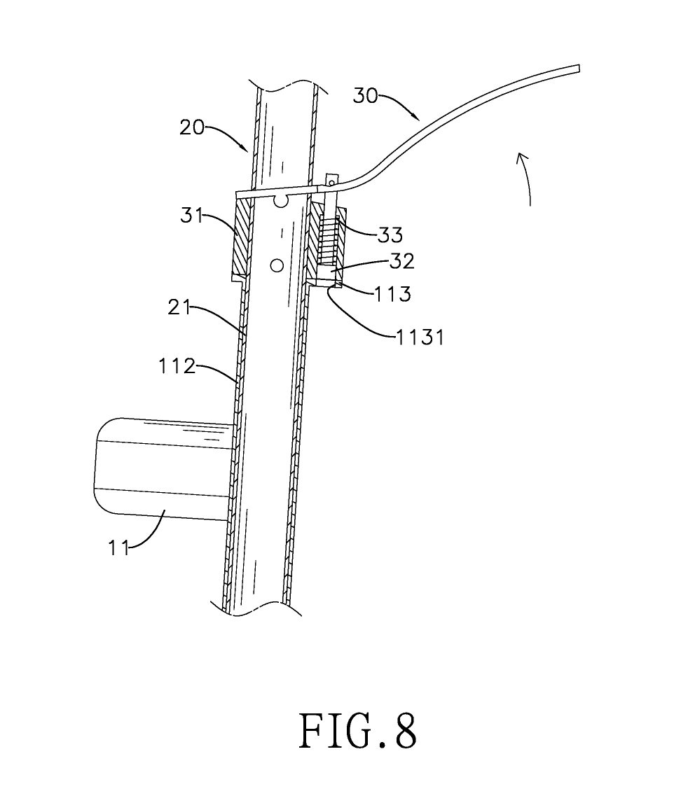

Referring to FIGS. 7 and 8, each connecting unit 11 includes a connecting sheet 113 surrounding the second end 112. Two latch units 30 are oppositely disposed on junctions between the supporting members 20 and the connecting units 11. Each latch unit includes a sleeve 31 and a rod 32. The sleeve 31 is fitted to the corresponding supporting member 20, and the rod 32 is slidably disposed in the sleeve 31 and detachably inserted into a hole 1131 of the connecting sheet 113. When the walker is to be used, a spring 33 pushes the rod 32 into the hole 1131 so as to fix the position of the supporting member 20 relative to the connecting unit 11. When the walker is to be folded, the rod 32 is pulled out from the hole 1131 to allow the connecting unit 11 to rotate with respect to the corresponding supporting member 20.

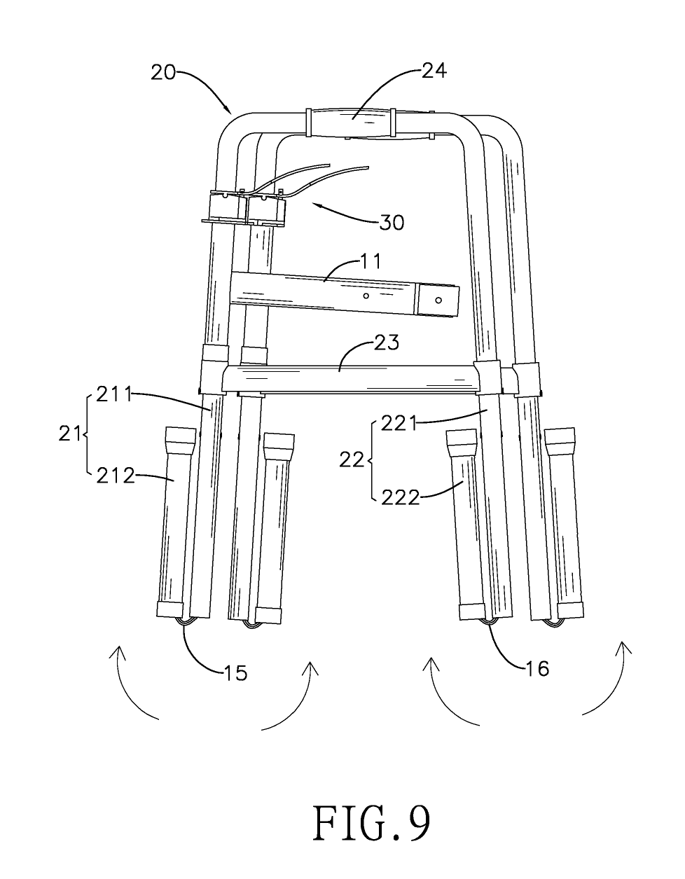

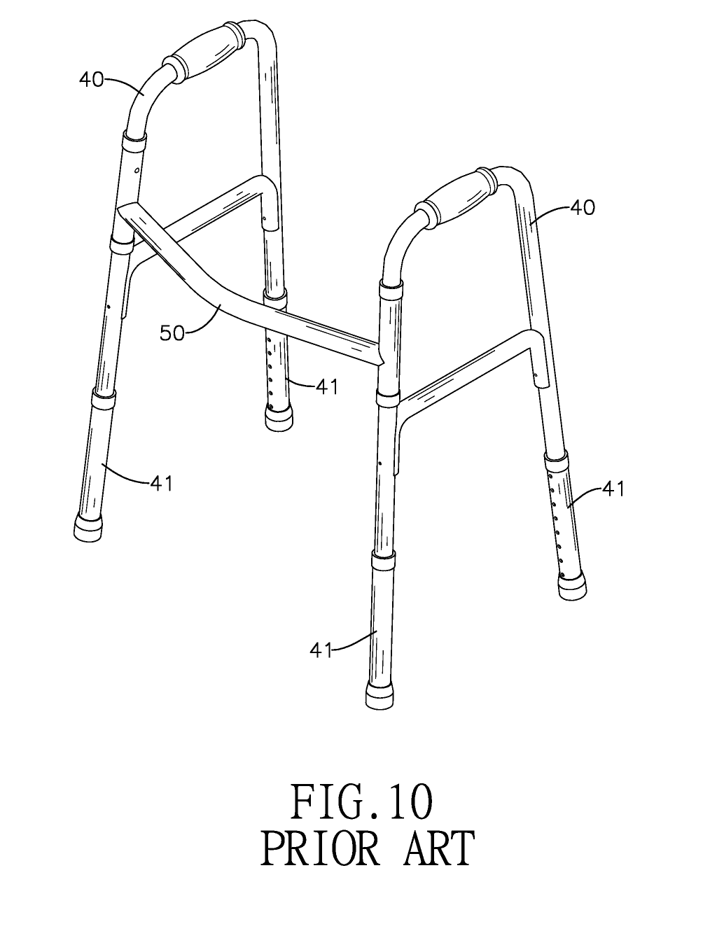

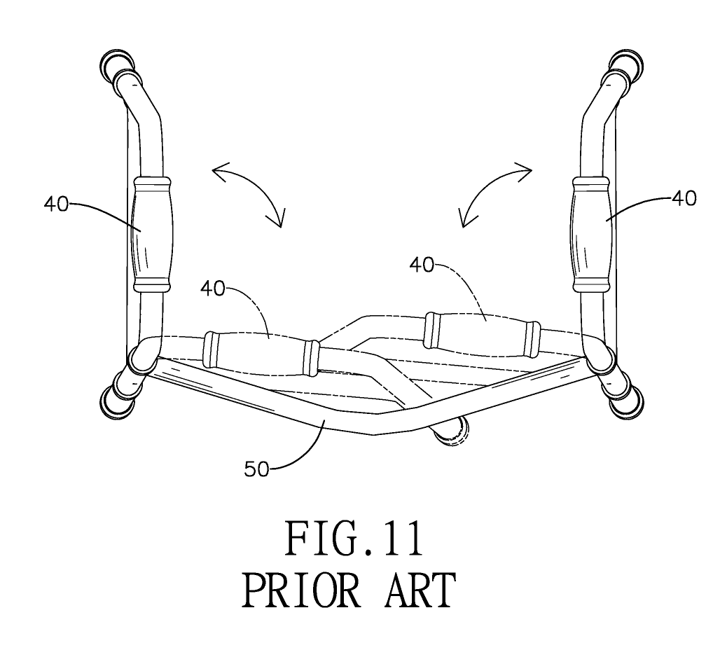

Referring to FIGS. 4 and 9, in another preferred embodiment, each front leg 21 includes a first section 211 and a second section 212, and each rear leg 22 includes a third section 221 and a fourth section 222. Since the front leg 21 has the same structure as the rear leg 22, only the structure of the rear leg 22 is described for the sake of clarity and conciseness. The fourth section 222 is fitted to the third section 221 and fixed to the third section 221 by the insertion of a protrusion 2211 into one of holes 2221. The protrusion 2211 can be inserted into different holes to regulate the position of the fourth section 222 so as to regulate the height of the walker. A second elastic member 15 is disposed between the first section 211 and the second section 212. The second elastic member 15 has two ends fixed to inner sides of the first section 211 and the second section 212 respectively. Similarly, a third elastic member 16 is disposed between the third section 221 and the fourth section 222. The third elastic member 16 has two ends fixed to inner sides of the third section 221 and the fourth section 222 respectively. Preferably, the second elastic member 15 and the third elastic member 16 are elastic cords. Referring to FIG. 9, the front leg 21 can be folded by separating the second section 212 from the first section 211. Similarly, the rear leg 22 can be folded by separating the fourth section 222 from the third section 221. The front leg 21 can be folded in the same way as the rear leg 22.

Since the connecting portion 10 includes the two connecting units 11, the connecting portion 10 can be folded to a reduced length, thereby facilitating the storage and reducing the volume to save the shipping cost, which has the effect of energy conservation and carbon reduction.

In addition, in a preferred embodiment, the first elastic member 13 facilitates the alignment and assembly of the two connecting units 11. In another embodiment, similarly, the second elastic member 15 also facilitates the alignment and assembly of the first and second sections 211, 212 and the alignment and assembly of the third and fourth sections 221, 222.

In addition, referring to FIG. 3, the fastening member 122A has a sufficient width for a user to hold the fastening member 122A for installing or removal of the fastening member 122A with respect to the connecting units 11. A trademark of the manufacturer or a user's manual can be printed on the surface of the fastening member 122A.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A walker, comprising:
a connecting portion comprising:
two connecting units, each connecting unit having a first end and a second end, the first end of one of the connecting units detachably connected to the first end of the other connecting unit; and
a fastening unit detachably disposed on a junction between the connecting units to connect the connecting units; and
two supporting members oppositely disposed and rotatably connected to the second ends of the connecting units respectively.

2. The walker as claimed in claim 1, wherein the first end of one of the connecting units is fitted to the first end of the other connecting unit.

3. The walker as claimed in claim 2, wherein the fastening unit comprises at least one plug detachably inserted into the connecting units and a fastening member connected to the at least one plug and abutting one of the connecting units.

4. The walker as claimed in claim 3, wherein the fastening member comprises an abutting portion detachably abutting the first end of the connecting unit, a fixed end formed at one end of the abutting portion and fixed to one side of the at least one plug, and a mounting end formed at another end of the abutting portion and detachably connected to another end of the at least one plug.

5. The walker as claimed in claim 3, wherein the fastening member comprises an abutting portion having two mounting ends detachably connected to the connecting units respectively, and the abutting portion is connected to the at least one plug and detachably abuts the first end of the connecting unit.

6. The walker as claimed in claim 5, wherein the mounting ends are horizontally connected to the connecting units.

7. The walker as claimed in claim 5, wherein the mounting ends are vertically connected to the connecting units.

8. The walker as claimed in claim 1, wherein the connecting units are hollow, and the connecting portion further comprises a first elastic member having two ends fixed to inner sides of the connecting units.

9. The walker as claimed in claim 5, wherein the connecting units are hollow, and the connecting portion further comprises a first elastic member having two ends fixed to inner sides of the connecting units.

10. The walker as claimed in claim 1 further comprising two latch units oppositely disposed at junctions between the supporting members and the connecting units and each latch unit comprising a sleeve fitted to the supporting member and a rod slidably disposed in the sleeve, wherein each connecting unit comprises a connecting sheet surrounding the second end, and the rod is detachably joined to the connecting sheet.

11. The walker as claimed in claim 9 further comprising two latch units oppositely disposed at junctions between the supporting members and the connecting units and each latch unit comprising a sleeve fitted to the supporting member and a rod slidably disposed in the sleeve, wherein each connecting unit comprises a connecting sheet surrounding the second end, and the rod is detachably joined to the connecting sheet.

12. The walker as claimed in claim 8 further comprising two latch units oppositely disposed at junctions between the supporting members and the connecting units, wherein each latch unit comprises a sleeve fitted to the supporting member and a rod slidably disposed in the sleeve, each connecting unit comprises a connecting sheet surrounding the second end, and the rod is detachably joined to the connecting sheet.

13. The walker as claimed in claim 9 further comprising two latch units oppositely disposed at junctions between the supporting members and the connecting units, wherein each latch unit comprises a sleeve fitted to the supporting member and a rod slidably disposed in the sleeve, each connecting unit comprises a connecting sheet surrounding the second end, and the rod is detachably joined to the connecting sheet.

14. The walker as claimed in claim 1, wherein each supporting member comprises a front leg, a rear leg and a transverse rod disposed between the front leg and the rear leg, an upper end of the front leg is joined to an upper end of the rear leg to form an armrest portion, and the second end of each connecting unit is fitted to the front leg correspondingly.

15. The walker as claimed in claim 5, wherein each supporting member comprises a front leg, a rear leg and a transverse rod disposed between the front leg and the rear leg, an upper end of the front leg is joined to an upper end of the rear leg to form an armrest portion, and the second end of each connecting unit is fitted to the front leg correspondingly.

16. The walker as claimed in claim 10, wherein each supporting member comprises a front leg, a rear leg and a transverse rod disposed between the front leg and the rear leg, an upper end of the front leg is joined to an upper end of the rear leg to form an armrest portion, the second end of each connecting unit is fitted to the front leg correspondingly, and the sleeve is fitted to the front leg.

17. The walker as claimed in claim 13, wherein each supporting member comprises a front leg, a rear leg and a transverse rod disposed between the front leg and the rear leg, an upper end of the front leg is joined to an upper end of the rear leg to form an armrest portion, the second end of each connecting unit is fitted to the front leg correspondingly, and the sleeve is fitted to the front leg.

18. The walker as claimed in claim 14, wherein each front leg comprises a first section, a second section detachably fitted to the first section, and a second elastic member connecting the first and second sections, and each rear leg comprises a third section, a fourth section detachably fitted to the third section, and a third elastic member connecting the third and fourth sections.

19. The walker as claimed in claim 16, wherein each front leg comprises a first section, a second section detachably fitted to the first section, and a second elastic member connecting the first and second sections, and each rear leg comprises a third section, a fourth section detachably fitted to the third section, and a third elastic member connecting the third and fourth sections.
